(19) United States
(12) Patent Application Publication
(10) Pub. No.: US 2026/0265040 A1
(43) Pub. Date: Sep. 10, 2026

(54) AUTOFILL PITCHER SYSTEM WITH SENSOR DETECTION

(71) Applicant: Haier US Appliance Solutions, Inc., Wilmington, DE (US)

(72) Inventors: Jordan Andrew Waymeyer, Louisville, KY (US); Jose Rafael Padron, Louisville, KY (US)

(21) Appl. No.: 19/070,682

(22) Filed: Mar. 5, 2025

(51) Int. Cl. B67D 1/08; B67D 1/00; F25D 23/12; F25D 29/00

(52) U.S. Cl. CPC B67D 1/0888; B67D 1/0014; F25D 23/126; F25D 29/005; B67D 2210/00144

(57) ABSTRACT

An autofill pitcher system includes a pitcher. The pitcher includes one or more pitcher walls and an internal volume defined within the pitcher wall(s). Additionally, the autofill pitcher system includes a dispenser defining a cavity. The cavity is configured to receive the pitcher. Furthermore, the dispenser includes a fill tube positioned and configured to direct water into the pitcher while the pitcher is received within the cavity. Moreover, the autofill pitcher system includes first and second magnets positioned within the pitcher. Additionally, the autofill pitcher system includes a sensor configured to detect a presence of the first and second magnets while the pitcher is received within the cavity of the dispenser.

### FIELD

The present subject matter relates generally to refrigerator appliances, and more particularly to autofill pitcher systems for refrigerator appliances.

### BACKGROUND

Some refrigerator appliances include autofill pitcher systems. Autofill pitcher systems typically include a dispensing housing and a pitcher. When the pitcher is positioned in a designated spot, e.g., beneath the autofill housing, water is automatically dispensed into the pitcher.

Some autofill pitcher systems use multiple sensors to detect various statuses of the pitcher system. For example, multiple sensors may be utilized to detect the presence of the pitcher, the liquid fill status of the pitcher, and/or the like. However, such pitcher systems are complex and costly to implement.

Accordingly, an autofill pitcher system that obviates one or more of the above-mentioned drawbacks would be beneficial.

### BRIEF DESCRIPTION

Aspects and advantages of the invention will be set forth in part in the following description, may be apparent from the description, or may be learned through practice of the invention.

In one exemplary aspect, a refrigerator appliance defining a lateral direction, a transverse direction, and a vertical direction is provided. The refrigerator appliance includes a cabinet. The cabinet defines a fresh food chamber. The refrigerator appliance also includes an autofill pitcher system. The autofill pitcher system includes a pitcher. The pitcher includes at least one pitcher wall and an internal volume defined within the at least one pitcher wall. Additionally, the autofill pitcher system includes a dispenser. The dispenser defines a cavity configured to receive the pitcher. Furthermore, the dispenser includes a fill tube. The fill tube is positioned and configured to direct a flow of water from a water supply into the internal volume of the pitcher while the pitcher is received within the cavity. Moreover, the autofill pitcher system includes a first magnet. The first magnet is positioned within the pitcher. Additionally, the autofill pitcher system includes a second magnet positioned within the pitcher. Furthermore, the autofill pitcher system includes a sensor. The sensor is configured to detect a presence of the first magnet and the second magnet while the pitcher is received within the cavity of the dispenser.

In another example aspect, a method of operating a refrigerator appliance defining a lateral direction, a transverse direction, and a vertical direction is provided. The refrigerator appliance includes a cabinet. The cabinet defines a fresh food chamber. Additionally, the refrigerator appliance includes an autofill pitcher system. The autofill pitcher system includes at least one pitcher wall and an internal volume defined within the at least one pitcher wall. Furthermore, the autofill pitcher system includes a dispenser. The dispenser defines a cavity. The method includes positioning a first magnet within the pitcher. Moreover, the method includes positioning a second magnet within the pitcher. Additionally, the method includes receiving the pitcher within the cavity of the dispenser. Furthermore, the method includes detecting, with a sensor, a presence of the first magnet. Moreover, the method includes directing a flow of water through a fill tube of the dispenser from a water supply and into the internal volume of the pitcher while the pitcher is received within the cavity. Additionally, the method includes detecting a presence of the second magnet.

In another example aspect, an autofill pitcher system is provided. The autofill pitcher system includes a pitcher defining a lateral direction, a transverse direction, and a vertical direction. The pitcher includes at least one pitcher wall and an internal volume defined within the at least one pitcher wall. Additionally, the autofill pitcher system includes a dispenser. The dispenser defines a cavity. The cavity is configured to receive the pitcher. The dispenser also includes a fill tube positioned and configured to direct a flow of water from a water supply into the internal volume of the pitcher while the pitcher is received within the cavity. Additionally, the autofill pitcher system includes a first magnet. The first magnet is positioned within the pitcher. Furthermore, the autofill pitcher system includes a second magnet. The second magnet is positioned within the pitcher. Moreover, the autofill pitcher system includes a sensor. The sensor is configured to detect a presence of the first magnet and the second magnet while the pitcher is received within the cavity of the dispenser.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to one or more exemplary embodiments of the present disclosure.

FIG. 2 provides a front view of the refrigerator appliance of FIG. 1 with refrigerator doors shown in an open configuration.

FIG. 3 provides a perspective view of a pitcher in accordance with one or more exemplary embodiments of the present disclosure.

FIG. 4 provides an enlarged side sectional view of a pitcher and lid in accordance with one or more exemplary embodiments of the present disclosure.

FIG. 5 provides an illustrative view of a pitcher received in a dispenser cavity in accordance with one or more exemplary embodiments of the present disclosure.

FIG. 6 provides an illustrative view of the pitcher of FIG. 5 received in the dispenser cavity.

FIG. 7 provides a flowchart illustrating an example method of operating a refrigerator appliance according to one or more example embodiments of the present disclosure.

The use of the same reference numbers in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

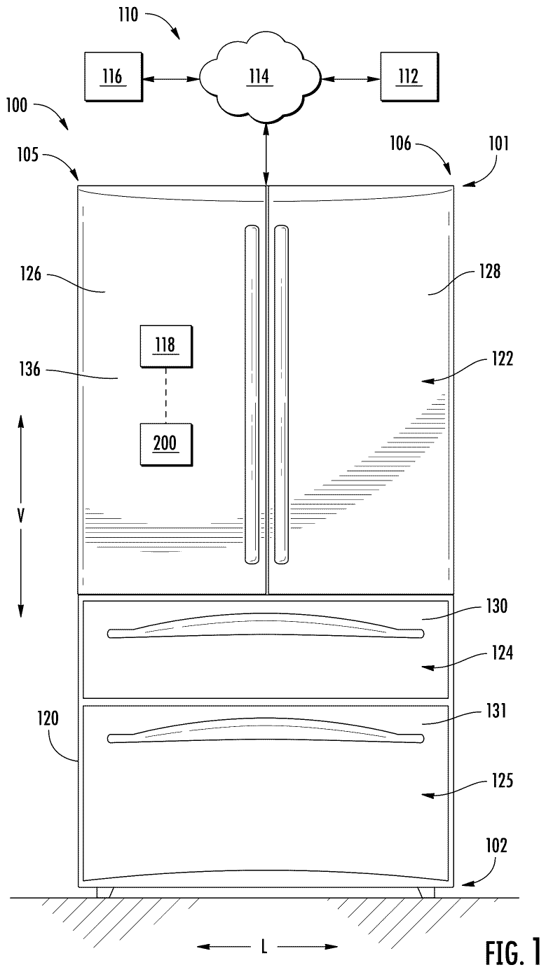

Turning to the figures, FIG. 1 provides a front view of an exemplary refrigerator appliance 100 according to one or more exemplary embodiments of the present disclosure. Refrigerator appliance 100 extends between a top 101 and a bottom 102 along a vertical direction V, between a left side 105 and a right side 106 along a lateral direction L, and extends between a front and a back along a transverse direction T (not shown), which is a direction orthogonal to the vertical direction V and the lateral direction L. Vertical direction V, lateral direction L, and transverse direction T are mutually perpendicular and form an orthogonal direction system.

Refrigerator appliance 100 includes a housing or cabinet 120 defining a chilled chamber, fresh food chamber 122, and one or more freezer chambers, such as a first freezer chamber 124 and a second freezer chamber 125, which may both be arranged below fresh food chamber 122 along the vertical direction V. In additional embodiments, the middle chamber may be a flexible chamber in place of first freezer chamber 124 and may be selectively operable at various temperatures for storing any desired food items, such as produce, wine, etc. As illustrated, fresh food chamber 122 is bounded by vertical walls at the left side 105 and at the right side 106, such walls spaced apart in the lateral direction, a horizontal wall at the top 101 and at the bottom by a lower wall 132. In this configuration, refrigerator appliance 100 may generally be referred to as a bottom mount, or bottom freezer, refrigerator. Cabinet 120 also defines a mechanical compartment (not shown) for receipt of a sealed cooling system (not shown).

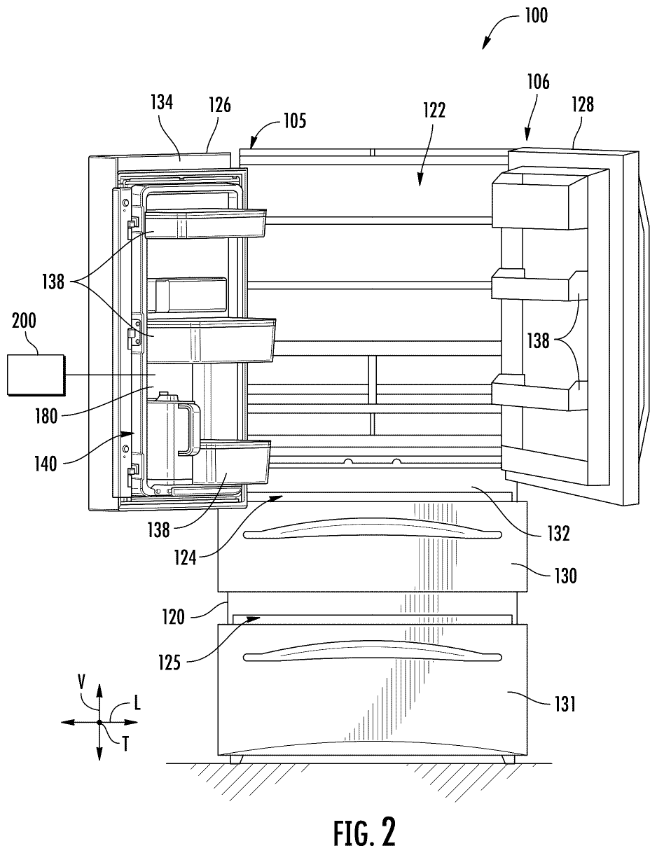

Left and right doors 126, 128, respectively, are rotatably hinged to an edge of cabinet 120 at left side 105 and right side 106, respectively, for accessing fresh food chamber 122 (FIG. 2) or sealing fresh food chamber 122 as illustrated in FIG. 1. For example, upper and lower hinges may couple each door 126, 128 to cabinet 120. When left and right doors 126, 128 are configured as illustrated in FIG. 1, the door arrangement is sometimes referred to as a “French door” configuration. Freezer doors, such as a first freezer door 130 and a second freezer door 131, may be arranged below doors 126, 128 for accessing one or more freezer chambers, such as first and second freezer chambers 124, 125, respectively. In the exemplary embodiment shown in FIG. 1, freezer doors 130, 131 are coupled to freezer drawers (not shown) slidably mounted within first and second freezer chambers 124, 125. Such drawers are thus generally “pull-out” drawers in that they may be manually moved into and out of freezer chambers 124, 125 on suitable slide mechanisms. Each door 126, 128, 130, 131 may include a handle for accessing one of the chambers 122, 124, 125 of refrigerator appliance 100.

Referring still to FIG. 1, a schematic diagram of an external communication system 110 will be described according to an exemplary embodiment of the present subject matter. In general, external communication system 110 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 110 may be used to transfer data or other information to improve performance of one or more external devices or appliances and/or improve user interaction with such devices.

For example, external communication system 110 permits controller 200 of refrigerator appliance 100 to communicate with a separate device external to refrigerator appliance 100, referred to generally herein as an external device 112. As described in more detail below, these communications may be facilitated using a wired or wireless connection, such as via a network 114. In general, external device 112 may be any suitable device separate from refrigerator appliance 100 that is configured to receive communications, information, or data from the controller 200 regarding the operation of refrigerator appliance 100 or provide commands from a user to the controller 200 of the refrigerator appliance 100. In this regard, external device 112 may be, for example, a personal phone, a smartphone, a tablet, a laptop or personal computer, a wearable device, a smart home system, or another mobile or remote device. Controller 200 is in operative communication with external device 112 through network 114 of external communication system 110.

In addition, a remote server 116 may be in communication with refrigerator appliance 100 and/or external device 112 through network 114. In this regard, for example, remote server 116 may be a cloud-based server 116, and is thus located at a distant location, such as in a separate state, country, etc., from the refrigerator appliance 100. In additional embodiments, the remote server 116 may be in the fog or the edge instead of the cloud. According to an exemplary embodiment, external device 112 may communicate with a remote server 116 over network 114, such as the Internet, to transmit/receive data or information, provide user inputs, receive user notifications or instructions, interact with or control refrigerator appliance 100, etc. In addition, external device 112 and remote server 116 may communicate with refrigerator appliance 100 to communicate similar information.

In general, communication between refrigerator appliance 100, external device 112, remote server 116, and/or other user devices or appliances may be carried using any type of wired or wireless connection and using any suitable type of communication network, non-limiting examples of which are provided below. For example, external device 112 may be in direct or indirect communication with refrigerator appliance 100 through any suitable wired or wireless communication connections or interfaces, such as network 114. For example, network 114 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 110 is described herein according to an exemplary embodiment of the present subject matter. However, it should be appreciated that the exemplary functions and configurations of external communication system 110 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

FIG. 2 provides a front perspective view of refrigerator appliance 100 showing doors 126, 128 in an open position to reveal the interior of fresh food chamber 122. Additionally, freezer doors 130, 131 are shown in partially open positions to reveal a portion of the interior of freezer chambers 124, 125, respectively.

Left door 126 of refrigerator appliance 100 includes an inner surface 134 and an outer surface 136. Inner surface 134 generally defines a portion of the interior of fresh food chamber 122 when left door 126 is in a closed position as shown in FIG. 1. Outer surface 136 is generally opposite inner surface 134 and defines a portion of the exterior of refrigerator appliance 100 when left door 126 is in the closed position.

The same construction may result in a similarly formed right door 128 as left door 126, with inner surface 134 and outer surface 136. Moreover, it will further be appreciated that freezer doors 130, 131 may likewise include inner and outer surfaces.

Doors 126, 128 may include storage bins or shelves 138 movably or fixedly attached to the inner surface 134 of the doors 126, 128. In the embodiment illustrated in FIG. 2, left door 126 includes an autofill pitcher system 140 in accordance with this disclosure. An access door 242 may be provided proximate to the autofill pitcher system 140, e.g., on the left door 126 in embodiments where the autofill pitcher system 140 is provided on the left door 126. Components of the autofill pitcher system 140 may be positioned behind the access door 242, such as a water filter (not shown). The autofill pitcher system 140 is illustrated on the left door 126 for convenience. In other embodiments, the autofill pitcher system 140 may be in a different position on the left door 126, or on the right door 128, or elsewhere within the fresh food chamber 122.

It will be appreciated that the present subject matter may be used with other types of refrigerator appliances as well, such as top mount, or top freezer, refrigerator appliances or single door refrigerators, among other possible variations. Consequently, the description set forth herein is not intended to limit the present subject matter in any aspect.

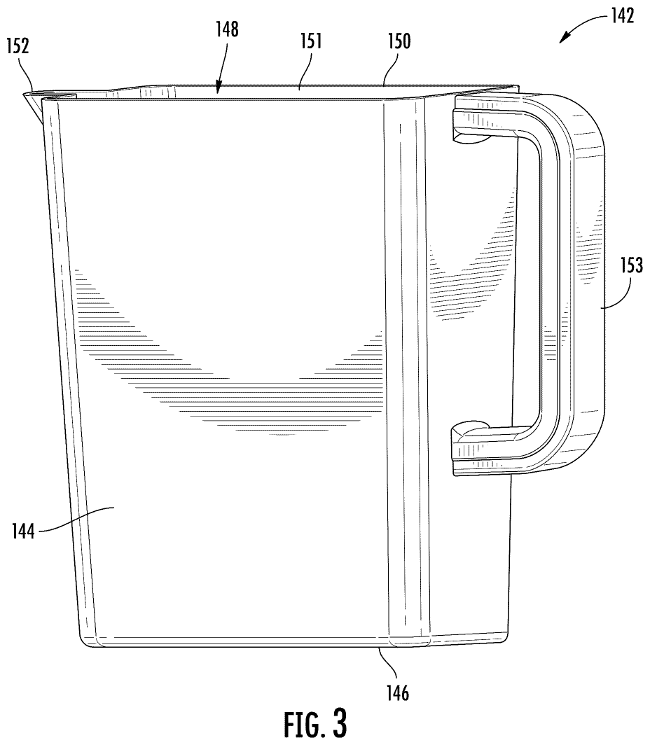

The autofill pitcher system 140 comprises a removable pitcher, pitcher 142, a dispenser 180, and controller 200. Further details of exemplary pitcher 142 may be seen with reference to FIGS. 3, 4, and 5. FIG. 3 is a perspective view of a representative pitcher 142 comprising a pitcher wall 144 connected to, or formed with, pitcher bottom 146. In the illustrated exemplary embodiment, the pitcher wall 144 is a single continuous side wall which extends completely around the outermost perimeter of the pitcher bottom 146 and extends upward from the pitcher bottom 146 generally along the vertical direction V. It should be understood that references herein throughout to the orthogonal direction system including vertical direction V, lateral direction L, and transverse direction T in the context of the pitcher 142 are with reference to when the pitcher 142 is docked in the dispenser cavity 181 and, in embodiments where the autofill pitcher system 140 is provided on a door of the refrigerator appliance, the door is in the closed position.

A top edge 150 is formed by the pitcher wall 144 at the pitcher end opposite pitcher bottom 146. The pitcher wall 144 and pitcher bottom 146 define an internal volume of the pitcher 142, i.e., a pitcher volume 148, accessible through opening 151 defined by the top edge 150. In additional embodiments, the pitcher 142 may include a plurality of side walls which collectively extend completely around the outermost perimeter of the pitcher bottom 146 and thereby define the internal volume of the pitcher 142, e.g., pitcher volume 148 may be enclosed on four sides (such as front, back, left, and right) by one or more side walls and on a fifth side (e.g., bottom) by the pitcher bottom 146, and the pitcher volume 148 may be open on the sixth side, e.g., at the top edge 150.

For convenience, top edge 150 may also define a spout 152 at a first end of the pitcher 142 to facilitate directing liquid into, or out of, the pitcher 142. At a second end of the pitcher, opposite the spout 152, a handle 153 may be included to provide a gripping area to aid in manipulating the pitcher 142.

Exemplary pitcher 142 is illustrated as a generally hollow rectangular cuboid for ease of illustration only. Other embodiments may have other shapes, for example a hollow cylinder, or may be non-prismatic, among other possible examples, and may or may not have features such as a spout or a handle.

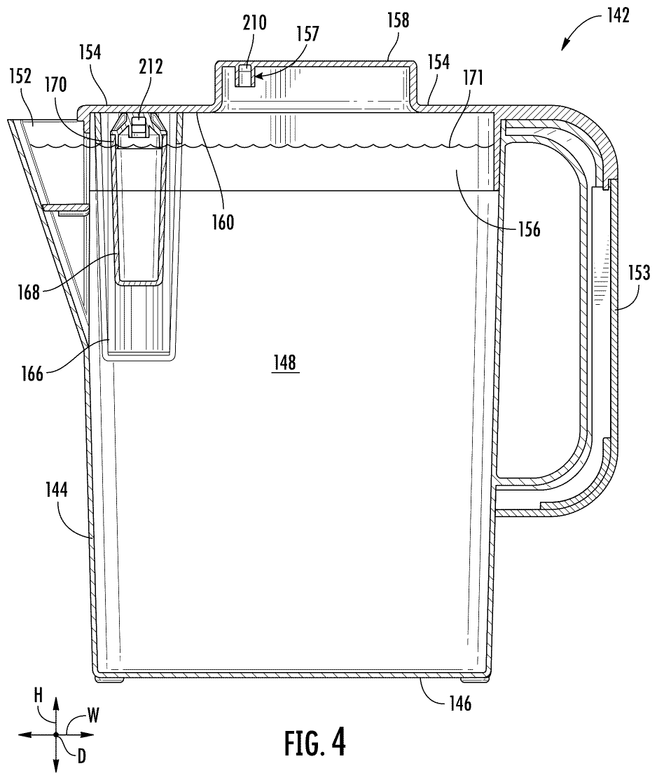

As illustrated in FIG. 4, embodiments of pitcher 142 may include a lid 154 removably received in, and fitted to, the opening 151 at the top edge 150. The lid 154 may include a peripheral skirt 156 configured to be removably received in the opening 151 of pitcher 142. Some embodiments of the skirt 156 may include features (not shown) that engage an inner portion of pitcher wall 144 at the top edge 150 to secure the lid against accidental separation from the pitcher 142, such as one or more gaskets, tabs, and/or ridges which extend at least partially around the skirt 156 and engage or interact with the inner surface of one or more side walls of the pitcher 142. Lid 154 may include a top wall 158 joined to, or formed with, the skirt 156. Thus, the lid 154 and, particularly, the top wall 158 thereof, may cooperate with the pitcher 142 to fully enclose the internal volume 148 when the lid 154 is received in the opening 151.

In accordance with embodiments of this disclosure, lid 154 may include a channel 166 affixed to, or formed with, lid 154. Channel 166 is generally cylindrical in shape with the longitudinal axis generally parallel to the vertical direction V (as noted above, such direction is with reference to when the pitcher 142 is received in the cavity of the dispenser). The wall of the channel 166 may be perforated or sections removed to allow fluid communication with the pitcher volume 148. In embodiments, water contained in the pitcher volume 148 may freely enter and flow out of the channel 166.

Float body 168 is illustrated as a generally cylindrical body for ease of illustration. Other shapes for the float body may be used as will be apparent. Float body 168 is disposed inside channel 166 and constrained for displacement, i.e., to allow free or generally free movement, in the vertical direction V. Float body 168 may move vertically between a first position in which the first end 170 of float body 168 is proximate to the inner surface 160 of lid 154 (FIG. 4) and a second position (not shown) where the first end 170 is spaced apart from the inner surface 160.

Float body 168 is a generally hollow structure formed or sealed to be at least liquid tight against intrusion of liquid (e.g., water). The float body 168 is configured to rise generally in the vertical direction V in reaction to the fluid level 171 in the internal volume 148 of the pitcher 142. For example, in FIG. 4, fluid level 171 is at a maximum desirable or full pitcher level and the float body 168 is at the first position, an upper position due to the buoyancy of the float body 168 in the liquid (e.g., water). As will be described below, a sensor trigger, specifically a magnet, may be positioned in the first end 170 of float body 168. For example, the magnet may interact with a sensor when the pitcher 142 is received in the cavity of the dispenser and the fluid level 171 is at the full pitcher level to indicate the pitcher is full and a fill operation may be stopped.

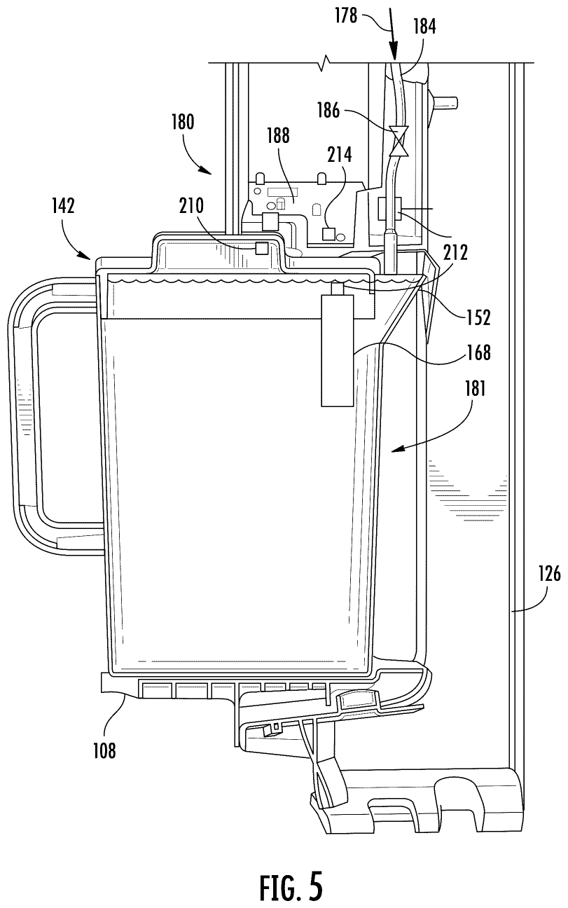

As illustrated for example in FIG. 5, dispenser 180 defines a cavity 181 to receive the pitcher 142. In the illustrative embodiment shown in the figures, the dispenser 180 is positioned on the inner surface 134 of left door 126 of the refrigerator appliance 100. Other embodiments may have the dispenser on other doors or elsewhere in the fresh food chamber 122. As illustrated, the cavity 181 comprises a support or shelf 108 to support the pitcher 142 in the vertical direction V and a sensor board 188 adjacent to the lid 154 of the pitcher 142. As illustrated, the shelf 108 is dedicated to support the pitcher 142 on the left door 126. In other embodiments, the shelf 108 may not be a dedicated shelf for the pitcher 142. The shelf 108 may have other or additional uses, for example storage of other food products on the door. In other embodiments, the shelf 108 may be within the cabinet 120. Other features (not shown) may be provided to secure the pitcher 142 in the cavity 181 during filling and as the left door 126 is open and closed to provide access to the fresh food chamber 122.

The dispenser 180 may include a fill tube 184 adapted to direct water from a water supply 178 to the pitcher 142. The water supply 178 may be, for example, a water utility supply or a private source water supply, such as a private well. A valve 186 may be provided in line with the fill tube 184 between the water supply and the pitcher 142 to selectively allow the flow of water to the pitcher 142. The valve is operatively coupled to the controller 200.

Controller 200 (FIGS. 1 and 2) controls the operation of the autofill pitcher system in that it interprets signals received from various sensors of the dispenser 180 and determines if the autofill operation should initiate and when it should stop. Controller 200 may include control circuits, a memory, clock(s), an input/output device such as user interface 118 (FIG. 1), and a microprocessor, such as a general purpose or special purpose microprocessor operable to execute programming instructions or micro-control code associated with the operation of the autofill pitcher system. Alternatively, controller 200 may be constructed without using a microprocessor, e.g., using a combination of discrete analog or digital logic circuitry to perform control functionality instead of relying on software. Controller 200 may perform a variety of computer-implemented functions and/or instructions (e.g. performing the methods, calculations and the like and storing relevant data as disclosed herein). It should be noted that controller 200 as disclosed herein are capable of and may be operable to perform any methods or associated method steps as disclosed herein.

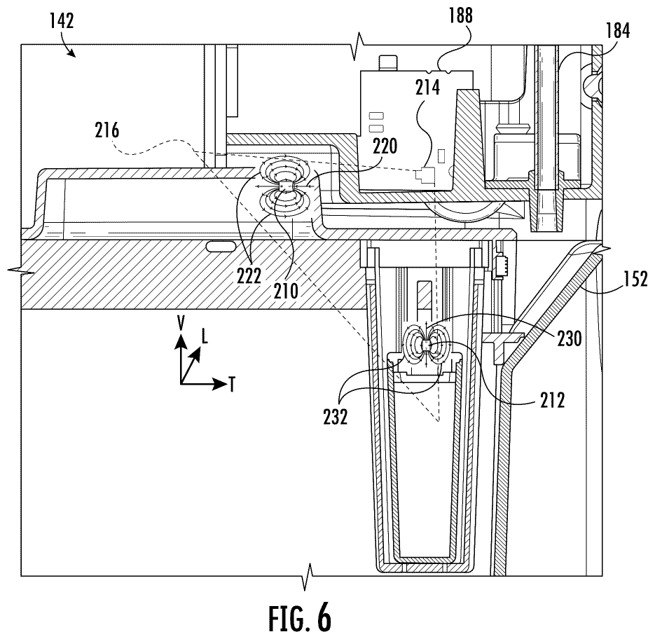

In the exemplary embodiment illustrated in FIGS. 5 and 6, the fill tube 184 is positioned directly above the spout 152 of the pitcher 142. In other embodiments, the fill tube 184 may be in other locations suitable to allow the flow of fluid (e.g., water) into the pitcher volume 148. Fluid flow to the pitcher continues until a stop flow event occurs and the controller 200 receives a signal contraindicating the flow of liquid into the pitcher 142.

Additionally, autofill pitcher system 140 includes one or more sensor triggers. For example, as illustrated in FIGS. 4 through 6, in some exemplary embodiments, autofill pitcher system 140 includes a first sensor trigger 210 and a second sensor trigger 212, which may be a first magnet 210 and a second magnet 212 respectively. The first magnet 210 and/or the second magnet 212 may be positioned within pitcher 142. For example, first magnet 210 may be positioned within lid 154 of pitcher 142, such as within a shaft 157 extending vertically downward from top wall 158 of lid 154 within pitcher 142 as illustrated in FIG. 4. The first magnet 210 may be fixedly attached to top wall 158 of lid 154 within shaft 157 so that movement of first magnet 210 relative to lid 154 and, thus, pitcher 142 while lid 154 is attached to pitcher 142, is constrained. Additionally, second magnet 212 may be fixedly coupled to float body 168 described above, such as to first end 170 of float body 168 as illustrated in FIGS. 4 and 6. As such, the second magnet 212 rises/is moved in the vertical direction V with float body 168 toward a sensor 214, which will be described below, as the internal volume 148 of pitcher 142 is filled with water or other liquid. For example, in FIG. 4, fluid level 171 of the liquid within internal volume 148 is at a maximum desirable or full pitcher level and the float body 168 and the second magnet 212 are at the first position, an upper position due to the buoyancy of the float body 168 in the liquid (e.g., water).

Furthermore, autofill pitcher system 140 includes a sensor 214 for detecting the presence of the first magnet 210 and the second magnet 212. As illustrated in FIGS. 5 and 6, sensor 214 may be part of sensor board 188 and positioned on sensor board 188 above cavity 181 of dispenser 180. As such, sensor 214 is positioned to detect the presence of the first magnet 210 and second magnet 212 while pitcher 142 is received within cavity 181 of dispenser 180.

According to some exemplary embodiments, sensor 214 is a single sensor 214 that is utilized to detect the presence of both the first magnet 210 and the second magnet 212 both separately and simultaneously. For example, sensor 214 may detect the presence of magnetic fields emanating from the magnets 210, 212 simultaneously while the magnets 210, 212 are both within a magnetic field detection range 216 of sensor 214. For example, while pitcher 142 is received within cavity 181 of dispenser 180, first magnet 210 is positioned relative to sensor 214 such that first magnet 210 is within magnetic field detection range 216 of sensor 214. As such, sensor 214 detects the presence of the magnetic field of first magnet 210 in response to receipt of pitcher 142 within cavity 181 of dispenser 180. Likewise, while pitcher 142 is received within cavity 181 of dispenser 180 and fluid level 171 within internal volume 148 of pitcher 142 is within a threshold water level range, float body 168 is positioned vertically within pitcher 142 such that second magnet 212 is within magnetic field detection range 216 of sensor 214. The threshold water level range may be a water level range of the fluid level 171 within which the float body 168 and, thus, the second magnet 212, are positioned vertically relative to sensor 214 such that second magnet 212 is within magnetic field detection range 216 of sensor 214. As such, sensor 214 detects the presence of second magnet 212 in response to the fluid level 171 within internal volume 148 of pitcher 142 falling within the threshold water level range. It should be appreciated that sensor 214 may also detect the presence of the magnetic field of only one of the first magnet 210 or the second magnet 212 while only one of the two magnets 210, 212 is within magnetic field detection range 216 of sensor 214. Furthermore, sensor 214 may be the only sensor 214 of autofill pitcher system 140 and refrigerator appliance 100 that may detect the presence of either first magnet 210 or second magnet 212.

According to some exemplary embodiments, first magnet 210 and second magnet 212 may be oriented differently from each other to permit sensor 214 to distinguish between first magnet 210 and second magnet 212. For example, as illustrated in FIG. 6, first magnet 210 may define a first magnetic axis 220. The first magnetic axis 220 is the magnetic axis defined between north and south poles of first magnet 210. The first magnet 210 may be oriented within pitcher 142 such that the first magnetic axis 220 is generally perpendicular to the vertical direction V, e.g., such as generally parallel to the transverse direction T or the lateral direction L, while the pitcher 142 is received within cavity 181 of dispenser 180. Furthermore, as illustrated in FIG. 6, a first magnetic field 222 may emanate concentrically from first magnetic axis 220 both vertically above first magnetic axis 220 and vertically below first magnetic axis 220. Likewise, as illustrated in FIG. 6, second magnet 212 may define a second magnetic axis 230. The second magnetic axis 230 is the magnetic axis defined between north and south poles of second magnet 212. The second magnet 212 may be oriented within pitcher 142 such that the second magnetic axis 230 is generally perpendicular to the transverse direction T and the lateral direction L while the pitcher 142 is received within cavity 181 of dispenser 180. As such, second magnet 212 may be oriented relative to first magnet 210 such that the second magnetic axis 230 is generally perpendicular to the first magnetic axis 220. Furthermore, as illustrated in FIG. 6, a second magnetic field 232 may emanate concentrically from second magnetic axis 230 on both sides of second magnetic axis 230, which are first and second transverse or lateral sides of second magnetic axis 230.

Since first magnet 210 and second magnet 212 are oriented differently from each other as described above, sensor 214 may detect differences between first magnetic field 222 and second magnetic field 232 that permits sensor 214 to distinguish between and identify the presence of first magnet 210 and second magnet 212. For example, sensor 214 may detect differences in the strength of first magnetic field 222 and second magnetic field 232 due to the orientation of first magnet 210 and second magnet 212 relative to each other. Additionally, or alternatively, since magnetic fields are vectors, i.e., include magnitude and directional components, sensor 214 may detect differences between the direction/orientation of first magnetic field 222 and second magnetic field 232 due to the orientation of first magnet 210 and second magnet 212 relative to each other.

According to some exemplary embodiments, sensor 214 is operatively or communicatively coupled to controller 200. As such, upon receipt of pitcher 142 within cavity 181 of dispenser 180, controller 200 may receive a signal from sensor 214 indicating that sensor 214 has detected the presence of first magnet 210. As a result, controller 200 may determine that pitcher 142 has been received within cavity 181 of dispenser 180 in response to sensor 214 detecting the presence of first magnet 210. After determining that pitcher 142 has been received within cavity 181, controller 200 may operate valve 186 to permit the flow of liquid, e.g., water, through fill tube 184 and into internal volume 148 of pitcher 142. As fluid level 171 within pitcher 142 rises as internal volume 148 is filled with liquid, float body 168 and, thus, second magnet 212, move upward or rise in vertical direction V, which is toward sensor 214. Once fluid level 171 is within the threshold water level range, second magnet 212 is within magnetic field detection range 216 of sensor 214 and, thus, second magnet 212 is detected by sensor 214. As such, controller 200 may receive a signal from sensor 214 that sensor 214 has detected the presence of second magnet 212. In this respect, controller 200 operates valve 186 as described above to fill pitcher 142 with water until controller 200 receives the signal from sensor 214 that sensor 214 has detected the presence of second magnet 212, which indicates that pitcher 142 is full of water. Once controller 200 has received such signal, controller 200 halts operation of valve 186 to cease the flow of water into pitcher 142.

Notably, the signals received by controller 200 from sensor 214 that sensor 214 has detected the presence of first magnet 210 and/or second magnet 212 identify/distinguish between the presence of first magnet 210 and second magnet 212. In this respect, sensor 214 may distinguish between the presence of first magnet 210 and second magnet 212. For example, as described above, first magnet 210 and second magnet 212 may be oriented relative to each other such that first magnetic axis 220 and second magnetic axis 230 are approximately perpendicular to each other, e.g., first magnetic axis 220 approximately perpendicular to vertical direction V and second magnetic axis 230 approximately perpendicular to lateral direction L and transverse direction T. As such, the magnetic fields 222, 232 emitted by the magnets 210, 212 are oriented differently. In this respect, sensor 214 may detect differences between the magnetic fields 222, 232, e.g., magnitudes, directions, that permit sensor 214 to distinguish when sensor 214 has detected first sensor trigger 210 and when sensor 214 has detected second sensor trigger 212. As such, the signals transmitted by sensor 214 to controller 200 and received by controller 200 identify/distinguish between the presence of first magnet 210 and second magnet 212. In this respect, controller 200 may determine when pitcher 142 has been received within cavity 181 of dispenser 180 and when to operate/halt operation of valve 186.

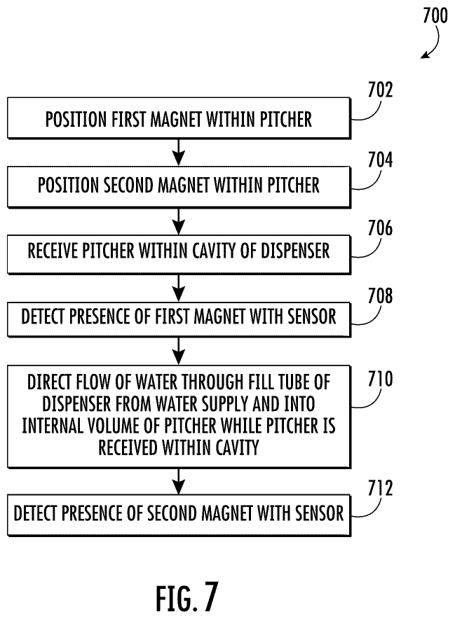

Turning now to FIG. 7, steps performed in a particular order for purposes of illustration and discussion are depicted. Those of ordinary skill in the art, using the disclosures provided herein, will understand that the steps of the method 700 may be modified, adapted, rearranged, omitted, interchanged, or expanded in various ways without deviating from the scope of the present disclosure.

As shown in FIG. 7, the method 700 includes positioning a first magnet within the pitcher, e.g., as indicated at (702) in FIG. 7. Specifically, the first magnet 210 may be positioned within pitcher 142 as described above. For example, the first magnet 210 may be fixedly attached to top wall 158 of lid 154 within shaft 157 as described above, oriented within pitcher 142 such that first magnetic axis 220 is approximately perpendicular to the vertical direction V while pitcher 142 is received within cavity 181, and/or oriented within pitcher 142 relative to the second magnet 212 such that first magnetic axis 220 is approximately perpendicular to second magnetic axis 230.

Moreover, the method 700 includes positioning a second magnet within the pitcher, e.g., as indicated at (704) in FIG. 7. Specifically, the second magnet 212 may be positioned within pitcher 142 as described above. For example, the second magnet 212 may be fixedly coupled to float body 168 described above, such as to first end 170 of float body 168, oriented within pitcher 142 such that second magnetic axis 230 is approximately parallel to the vertical direction V while pitcher 142 is received within cavity 181, and/or oriented within pitcher 142 relative to the first magnet 210 such that second magnetic axis 230 is approximately perpendicular to first magnetic axis 220.

Additionally, the method 700 includes receiving the pitcher within the cavity of the dispenser, e.g., as indicated at (706) in FIG. 7. Specifically, pitcher 142 may be received within cavity 181 of dispenser 180 as described above.

Furthermore, the method 700 includes detecting, with a sensor, a presence of the first magnet, e.g., as indicated at (708) in FIG. 7. Specifically, the presence of the first magnet 210 may be detected by the sensor 214 as described above. For example, the presence of the first magnet 210 may be detected by the sensor 214 in response to pitcher 142 being received within cavity 181. Furthermore, the sensor 214 may distinguish between the presence of the first magnet 210 and the presence of the second magnet 212 as described above. In some embodiments, after distinguishing between the presence of the first magnet 210 and the second magnet 212, sensor 214 may transmit, and controller 200 may receive, a signal from sensor 214 that distinguishes between first magnet 210 and second magnet 212. In some exemplary embodiments, sensor 214 is the only sensor 214 of autofill pitcher system 140 that is configured to detect the presence of the first magnet 210 or the second magnet 212.

Furthermore, in some embodiments, the method 700 includes determining that the pitcher has been received within the cavity of the dispenser in response to the sensor detecting the presence of the first magnet. Specifically, controller 200 may determine that pitcher 142 has been received within cavity 181 in response to sensor 214 detecting the presence of first magnet 210.

Moreover, the method 700 includes directing a flow of water through a fill tube of the dispenser from a water supply and into the internal volume of the pitcher while the pitcher is received within the cavity, e.g., as indicated at (710) in FIG. 7. Specifically, the flow of water may be directed through fill tube 184 of dispenser 180 from the water supply 178 and into internal volume 148 of pitcher 142 while pitcher 142 is received within cavity 181 as described above.

Additionally, the method 700 includes detecting, with the sensor, a presence of the second magnet, e.g., as indicated at (712) in FIG. 7. Specifically, the presence of the second magnet 212 may be detected by the sensor 214 as described above. For example, the presence of the second magnet 212 may be detected by the sensor 214 in response to the fluid level within internal volume 148 of pitcher 142 falling within the threshold water level range while directing the flow of water into internal volume 148. In this respect, float body 168 and, thus, second magnet 212, may float upward in vertical direction V toward sensor 214. Furthermore, the sensor 214 may distinguish between the presence of the first magnet 210 and the presence of the second magnet 212 as described above.

Moreover, in some embodiments, the method 700 may include operating a valve of the autofill pitcher system to permit the flow of water through the fill tube and into the internal volume of the pitcher until the sensor has detected the presence of the second magnet. Specifically, controller 200 may operate, e.g., open, valve 186 of autofill pitcher system 140 to permit the flow of water through fill tube 184 and into internal volume 148 of pitcher 142 until sensor 214 has detected the presence of second magnet 212.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A refrigerator appliance defining a lateral direction, a transverse direction, and a vertical direction, the refrigerator appliance comprising:
a cabinet defining a fresh food chamber; and
an autofill pitcher system comprising:
a pitcher comprising at least one pitcher wall and an internal volume defined within the at least one pitcher wall;
a dispenser defining a cavity, the cavity configured to receive the pitcher, the dispenser comprising a fill tube positioned and configured to direct a flow of water from a water supply into the internal volume of the pitcher while the pitcher is received within the cavity;
a first magnet positioned within the pitcher;
a second magnet positioned within the pitcher; and
a sensor configured to detect a presence of the first magnet and the second magnet while the pitcher is received within the cavity of the dispenser.

2. The refrigerator appliance of claim 1, wherein:
the sensor detects the presence of the first magnet in response to receipt of the pitcher within the cavity of the dispenser; and
the sensor detects the presence of the second magnet in response to a fluid level within the internal volume of the pitcher falling within a threshold water level range while the pitcher is received within the cavity.

3. The refrigerator appliance of claim 1, wherein:
the first magnet is fixed relative to the pitcher; and
the second magnet is movable in the vertical direction toward the sensor while the pitcher is received within the cavity of the dispenser as the internal volume of the pitcher is filled with water.

4. The refrigerator appliance of claim 1, wherein:
the first magnet defines a first magnetic axis, the first magnet oriented within the pitcher such that the first magnetic axis is approximately perpendicular to the vertical direction while the pitcher is received within the cavity of the dispenser; and
the second magnet defines a second magnetic axis, the second magnet oriented within the pitcher such that the second magnetic axis is approximately parallel to the vertical direction while the pitcher is received within the cavity of the dispenser.

5. The refrigerator appliance of claim 1, wherein:
the first magnet defines a first magnetic axis;
the second magnet defines a second magnetic axis; and
the first magnet and the second magnet are oriented relative to each other such that the first magnetic axis and the second magnetic axis are approximately perpendicular to each other.

6. The refrigerator appliance of claim 1, wherein the sensor is a single sensor of the autofill pitcher system configured to detect the presence of the first magnet or the presence of the second magnet.

7. The refrigerator appliance of claim 1, further comprising:
a controller operatively coupled to the sensor, the controller configured to receive a signal from the sensor distinguishing between the first magnet and the second magnet while the first magnet and the second magnet are oriented such that magnetic axes of the first magnet and the second magnet are approximately perpendicular to each other.

8. The refrigerator appliance of claim 1, further comprising:
a controller operatively coupled to the sensor, the controller configured to:
determine that the pitcher has been received within the cavity of the dispenser in response to the sensor detecting the presence of the first magnet; and
operate a valve to permit the flow of water through the fill tube and into the internal volume of the pitcher until the controller receives a signal from the sensor that the sensor has detected the presence of the second magnet.

9. A method of operating a refrigerator appliance defining a lateral direction, a transverse direction, and a vertical direction, the refrigerator appliance comprising a cabinet defining a fresh food chamber and an autofill pitcher system, the autofill pitcher system including a pitcher including at least one pitcher wall and an internal volume defined within the at least one pitcher wall, the autofill pitcher system also including a dispenser defining a cavity, the method comprising:
positioning a first magnet within the pitcher;
positioning a second magnet within the pitcher;
receiving the pitcher within the cavity of the dispenser;
detecting, with a sensor, a presence of the first magnet;
directing a flow of water through a fill tube of the dispenser from a water supply and into the internal volume of the pitcher while the pitcher is received within the cavity; and
detecting, with the sensor, a presence of the second magnet.

10. The method of claim 9, wherein:
the presence of the first magnet is detected by the sensor in response to receiving the pitcher within the cavity of the dispenser; and
the presence of the second magnet is detected by the sensor in response to a fluid level within the internal volume of the pitcher falling within a threshold water level range while directing the flow of water into the internal volume of the pitcher.

11. The method of claim 9, wherein:
positioning the first magnet within the pitcher comprises fixedly positioning the first magnet relative to the pitcher; and
the method further comprises moving the second magnet in the vertical direction toward the sensor by directing the flow of water into the internal volume of the pitcher while the pitcher is received within the cavity of the dispenser.

12. The method of claim 9, wherein:
positioning the first magnet within the pitcher comprises orienting the first magnet within the pitcher such that a first magnetic axis defined by the first magnet is approximately perpendicular to the vertical direction while the pitcher is received within the cavity of the dispenser; and
positioning the second magnet within the pitcher comprises orienting the second magnet within the pitcher such that a second magnetic axis defined by the second magnet is approximately parallel to the vertical direction while the pitcher is received within the cavity of the dispenser.

13. The method of claim 9, wherein:
positioning the first magnet within the pitcher comprises orienting the first magnet relative to the second magnet such that a first magnetic axis defined by the first magnet is approximately perpendicular to a second magnetic axis defined by the second magnet; and
positioning the second magnet within the pitcher comprises orienting the second magnet relative to the first magnet that the second magnetic axis is approximately perpendicular to the first magnetic axis.

14. The method of claim 9, wherein:
the sensor is a single sensor of the autofill pitcher system configured to detect the presence of the first magnet or the second magnet; and
detecting the presence of the first magnet and the second magnet comprises detecting the presence of the first magnet and the second magnet with the single sensor.

15. The method of claim 9, further comprising:
receiving, with a controller, a signal from the sensor distinguishing between the first magnet and the second magnet while the first magnet and the second magnet are oriented such that magnetic axes of the first magnet and the second magnet are approximately perpendicular to each other.

16. The method of claim 9, further comprising:
determining, with a controller, that the pitcher has been received within the cavity of the dispenser in response to the sensor detecting the presence of the first magnet; and
operating, with the controller, a valve to permit the flow of water through the fill tube and into the internal volume of the pitcher until the controller receives a signal from the sensor that the sensor has detecting the presence of the second magnet.

17. An autofill pitcher system, comprising:
a pitcher defining a lateral direction, a transverse direction, and a vertical direction, the pitcher comprising at least one pitcher wall and an internal volume defined within the at least one pitcher wall;
a dispenser defining a cavity, the cavity configured to receive the pitcher, the dispenser comprising a fill tube positioned and configured to direct a flow of water from a water supply into the internal volume of the pitcher while the pitcher is received within the cavity;
a first magnet positioned within the pitcher;
a second magnet positioned within the pitcher; and
a sensor configured to detect a presence of the first magnet and the second magnet while the pitcher is received within the cavity of the dispenser.

18. The autofill pitcher system of claim 17, wherein:
the first magnet defines a first magnetic axis, the first magnet oriented within the pitcher such that the first magnetic axis is approximately perpendicular to the vertical direction while the pitcher is received within the cavity of the dispenser; and
the second magnet defines a second magnetic axis, the second magnet oriented within the pitcher such that the second magnetic axis is approximately parallel to the vertical direction while the pitcher is received within the cavity of the dispenser.

19. The autofill pitcher system of claim 17, wherein:
the first magnet defines a first magnetic axis;
the second magnet defines a second magnetic axis; and
the first magnet and the second magnet are oriented relative to each other such that the first magnetic axis and the second magnetic axis are approximately perpendicular to each other.

20. The autofill pitcher system of claim 17, further comprising:
a controller operatively coupled to the sensor, the controller configured to receive a signal from the sensor distinguishing between the first magnet and the second magnet while the first magnet and the second magnet are oriented such that magnetic axes of the first magnet and the second magnet are approximately perpendicular to each other.
